(19) United States
(12) Patent Application Publication
(10) Pub. No.: US 2026/0093236 A1
(43) Pub. Date: Apr. 2, 2026

(54) METHOD FOR CHANGING AN OPERATING STATE OF A MACHINE TOOL AND MACHINE TOOL

(71) Applicant: Hilti Aktiengesellschaft, Schaan (LI)

(72) Inventors: Daniel WIEDERRICH, Schwabmuenchen (DE); Maryam EFTEKHARI, Untermeitingen (DE)

(21) Appl. No.: 19/110,999

(22) PCT Filed: Sep. 21, 2023
(86) PCT No.: PCT/EP2023/076054

§ 371 Date: Mar. 12, 2025

(30) Foreign Application Priority Data
Oct. 6, 2022 (EP) 22199926.1

(51) Int. Cl. G05B 19/404

(52) U.S. Cl. CPC G05B 19/404; G05B 2219/32184

(57) ABSTRACT

Various methods for changing an operating state of a machine tool are provided. A machine tool has an acceleration sensor, wherein the acceleration of the machine tool may be recorded in the three spatial directions by the acceleration sensor. Based on these values, a total acceleration may be ascertained, which may be compared with a threshold value a_drop. The machine tool may be switched off, for example, or change its operating state if the total acceleration exceeds the threshold value a_drop for longer than a time period t_drop. According to an alternative method for changing an operating state of a machine tool, the machine tool may be switched off or change its operating state if the total acceleration is below the threshold value a_drop for longer than a time period t_min_drop_impact and exceeds a second threshold value a_impact within a time period t_post_drop_impact. A machine tool for carrying out one of the methods for changing an operating state of the machine tool.

The present invention relates to various methods for changing an operating state of a machine tool.

### BACKGROUND

Machine tools typically have switching devices for switching the machine tool on or off. Such switching devices or switches for machine tools may be designed, for example, as actuating switches or switching devices with a catch function. In the case of actuating switches, the actuating switch must be actuated by a user the entire time during the operation of the machine tool in order to ensure the operation of the machine tool. If such a machine is dropped, it switches off automatically and independently due to the lack of actuation. This may significantly reduce the possible safety risk posed by such a machine tool being dropped.

In the case of machine tools which are equipped with a switching device having a catch function, such automatic and independent switch-off may not be realized in this way since the machine remains active even when dropped and the tool of the machine tool continues to move, in most cases rotate.

In the prior art, various methods are known for switching off, decelerating or otherwise changing an operating state of such machine tools, which have a switching device with a catch function, in the event of the machine tool being dropped.

### SUMMARY OF THE INVENTION

For example, it is known in the prior art to provide sensors in the grip region of the machine tool, which may detect whether or not the machine is being held by the user. The machine tool may only be operated if the-in most cases capacitive-sensors detect that active actuation of the machine by a user is ensured, i.e. if the user is holding the machine tool securely and contact with the machine tool is detected by the sensors in the handle of the machine tool. Such sensors are frequently based on capacitance measurements and are disadvantageous in that the user's hand must be positioned very precisely over the corresponding sensors on the grip of the machine tool in order to be detected. Moreover, the detection of the user's hand may be hampered by dirt or by the user wearing a glove. Moreover, it has been shown that integrating sensors in the handle of the machine tool, which is often low on space, may be very complex and laborious.

It is an object of the present invention to overcome the above-described deficiencies and disadvantages of the prior art and to provide a method for changing an operating state of a machine tool, with which dangerous situations may be reliably detected and which may bring about a swift and reliable switch-off of the machine tool, for example. Experts would welcome the provision of a solution which could be implemented in the machine tool in a particularly simple and straightforward manner, involving little effort. Moreover, in the context of the invention, the aim is to provide a machine tool for carrying out the method.

The present invention provides a method for changing an operating state of a machine tool. The method for changing an operating state of a machine tool is characterized by the following method steps:
a) providing a machine tool with an acceleration sensor,
b) recording an acceleration of the machine tool in the three spatial directions, whereby the acceleration values x, y and z are obtained,
c) ascertaining a total acceleration of the machine-tool total acceleration based on the acceleration values x, y and z,
d) comparing the total acceleration to a threshold value a_drop,
e) changing an operating state of the machine tool if the total acceleration falls below the threshold value a_drop for longer than a time period t_drop.

Advantageously, drop heights from a height of 45 cm may be particularly reliably detected using this method. The method for changing an operating state of the machine tool may be, for example, a method for switching off the machine tool if, for example, a dangerous situation is detected. The dangerous situation may consist, for example, in the machine tool falling to the ground, which may obviously present a danger to the user or bystanders if the machine is running. In addition to switching off the machine tool, a change in the operating state of the machine tool may also consist in decelerating the machine tool or its tool so that, for example, the motor of the machine tool rotates at a slower rate or speed or the tool of the machine tool rotates more slowly. Moreover, in the case of a change in an operating state of the machine tool, another operating mode may also be switched on.

The change in the operating state of the machine tool or the switch-off of the machine tool may advantageously take place whilst it is still in the air so that an injury to the user of the machine tool may be particularly reliably avoided. This first configuration of the invention is preferably also referred to as “drop detection” in accordance with the invention.

The invention is generally explained below using the example of switching off the machine tool. In this exemplary embodiment, the invention relates to a method for switching off a machine tool, wherein the machine tool may be switched off if the total acceleration falls below the threshold value a_drop for longer than a time period t_drop.

With the invention, it is possible to dispense with providing a capacitive sensor in the handle or with the complex integration of sensors in the housing of the machine tool. As a result, the electronics of the machine tool may be advantageously kept simple and a particularly compact and handy machine tool may be provided. Due to the software-based implementation of a method for changing an operating state of a machine tool, the reliable switch-off rate which may be achieved when required for safety reasons is surprisingly high.

In the context of the present invention, a machine tool having at least one acceleration sensor is provided. Many machine tools today already have acceleration sensors so that, in the context of the present invention, the evaluated acceleration data are, in particular, acceleration data which are “already” compiled, and therefore available. In the context of the present invention, these data, which are frequently already present, are supplied for additional evaluation in that they are used as a basis for the machine tool switching off automatically and independently. In the context of the present invention, it is advantageous that no additional effort is required to record data; instead, the use of data which are present “in any case” is often improved in that these data contribute to defining switch-off conditions for the machine tool.

In accordance with the invention, it is preferred that the gravitational acceleration of g=9.81 m/s² may be measured in an idle position of the machine tool. By way of example, the values for the gravitational acceleration in the three spatial directions x, y and z may be determined here as follows: a_x=0, a_y=0 and a_z=g=9.81 m/s². In accordance with the invention, it may also be preferred that an offset is applied to the ascertained values in order to normalize all three values for the acceleration to a value “zero”. In accordance with the invention, it is preferred that the further evaluation of the data is carried out depending on the determination methods for the gravitational acceleration in the three spatial directions. Depending on whether an offset is applied to the values, the ascertainment of the total acceleration or the underlying calculations for determining the conditions for switching off the machine tool may change. Whether an offset is used to normalize the acceleration values x, y and z to a common value, for example 0 m/s², or whether one of the acceleration values, for example the acceleration value z, is equated to the value of the gravitational acceleration g=9.81 m/s², may also depend, for example, on the sensor type which is used in the machine tool to ascertain the acceleration values x, y and z.

In the context of the present invention, acceleration data or values in the three spatial directions are compiled. A person skilled in the art knows the three spatial directions as axes of a three-dimensional Cartesian coordinate system. In accordance with the invention and to keep the language simple, the acceleration values are referred to as “x”, “y” and “z”, the acceleration value x being short for the acceleration a_x in the x direction, the acceleration value y being short for the acceleration a_y in the y direction and the acceleration value z being short for the acceleration value a_z in the z direction.

In a second aspect, the invention relates to a machine tool for carrying out the proposed method for changing an operating state of the machine tool, wherein the machine tool has a control apparatus and/or a processor for evaluating the acceleration data in addition to the at least one
acceleration sensor. In other words, the machine tool has a control apparatus and/or a processor, which is designed to evaluate the acceleration data or values ascertained by the at least one acceleration sensor. The control apparatus and/or the processor of the machine tool are designed, in particular, to ascertain a total acceleration a of the machine tool based on the acceleration values x, y and z in the three spatial directions. The total acceleration a of the machine tool is then compared to a threshold value a_drop, wherein the threshold value a_drop is preferably a predetermined threshold value.

In accordance with the invention, the wording “the threshold value a_drop is preferably a predetermined threshold value” preferably means that the threshold value a_drop cannot be set by a user of the machine tool, but is instead predetermined by the machine tool manufacturer, for example. By way of example, the threshold value a_drop may be stored in a memory in the control apparatus or in the machine tool. By way of example, look-up tables or the like may be used for this purpose. In accordance with the invention, it may also be preferred that data, such as threshold values, may be uploaded into the machine tool retrospectively during a maintenance or revision process. Changes to the threshold values, for example, may thus be communicated to the machine tool and new threshold values may be uploaded into the machine tool.

In the context of the present invention, an operating state of the machine tool may be changed if the total acceleration of the machine tool falls below the threshold value a_drop for longer than a time period t_drop. The machine tool may, in particular, preferably be switched off if the total acceleration falls below the threshold value a_drop for longer than a time period t_drop.

In accordance with the invention, the decrease in the total acceleration is preferably interpreted as the machine tool having been dropped, which means that the machine tool may be switched off if it is detected that the machine tool has been dropped. In the context of the configuration of the invention described here, it is, in particular, assumed that the machine tool has been dropped if the total acceleration falls below the threshold value a_drop for longer than a time period t_drop, wherein the time period t_drop preferably likewise represents a predetermined time period. The time period t_drop may be in the range of 0.1 to 1 second, for example. The threshold value a_drop may be, for example, between 5 and 60 % of the starting value for the total acceleration of the machine tool, wherein the starting value of the total acceleration is, in particular, ascertained during normal operation of the machine tool.

Since the switch-off of the machine tool or a change in the operating state of the machine tool is brought about by smart evaluation and processing of three-dimensional acceleration data, an important electronic safety function may be provided by the invention, wherein situations in which the machine tool is dropped may be detected particularly reliably by the invention. If it is detected that the machine tool has been dropped, the machine tool or its tool may be quickly brought to a stop so that a safety risk for the user may be minimized. It has been shown that particularly early detection of whether a machine tool has been dropped during operation is possible by means of the invention. Based on this quick detection, the machine tool may be switched off if it falls, so that dangerous situations may be avoided. According to the drop protection configuration of the invention, the proposed electronic safety function is characterized in that a switch-off of the machine tool or a change in the operating state of the machine tool takes place if the total acceleration falls below the threshold value a_drop and this falling below the threshold value a_drop continues for longer than a time period t_drop. The machine tool may preferably be switched off on reaching the end of the time period t_drop, i.e. if the end of the time period t_drop is reached and the total acceleration a is still below the threshold value a_drop. Alternatively, an operating state of the machine tool may be changed if the end of the time period t_drop is reached and the total acceleration a is still below the threshold value a_drop.

In accordance with the invention, it is preferred that the acceleration data ascertained by the acceleration sensor are filtered before being further processed, i.e. in particular before the total acceleration a is calculated.

In accordance with the invention, it is preferred that the time period t_drop has a start point t_drop_start and a stop point t_drop_stop. In other words, the time period t_ drop begins with the start point t_drop_start and the time period t_drop ends with the stop point t_drop_stop. In accordance with the invention, this preferably means that the points t_drop_start and t_drop_stop delimit the time period t_drop and represent the start and end points of the time period t_drop. According to the drop protection configuration of the invention, the machine tool is switched off on reaching the stop point t_drop_stop.

In accordance with the invention, it is preferred that a point t_drop_ start is recorded and a time recording is started if the total acceleration a falls below the threshold value a_drop. In other words, a time recording may begin if the total acceleration a falls below the threshold value a_drop. In other words, the start point of a predetermined time period t_drop is recorded, wherein the start point t_drop_start is characterized in that the total acceleration a falls below the threshold value a_drop. The switch-off of the machine tool or a change in an operating state of the machine tool preferably takes place at the stop point t_drop_stop of the time period t_drop, i.e. at the end of this time period.

In a second configuration of the invention, an alternative method for changing an operating state of a machine tool is presented, wherein the alternative method is characterized by the following method steps:
a) providing a machine tool with an acceleration sensor,
b) recording an acceleration of the machine tool in the three spatial directions, whereby the acceleration values x, y and z are obtained,
c) ascertaining the total acceleration,
d) comparing the total acceleration to a first threshold value a_drop,
e) changing an operating state of the machine tool if the total acceleration falls below the threshold value a_drop for longer than a time period t_min_drop_impact and the total acceleration exceeds a second threshold value a_impact within a time period t_post_drop_impact.

In this configuration of the invention, it is provided that the machine tool is switched off or changes its operating state if the total acceleration falls below the threshold value a_drop for longer than a time period t_min_drop_impact and the total acceleration exceeds a second threshold value a_impact within a time period t_post_drop_impact.

In this configuration of the invention, the total acceleration firstly falls below the first threshold value a_drop, wherein the total acceleration in this scenario does not fall below the first acceleration a_drop for long enough to bring about a switch-off of the machine tool or a change in an operating state of the machine tool. The total acceleration remains below the first threshold value a_drop for longer than a time period t_min_drop_impact. The time period t_min_drop_impact may be in the range of 0.05 to 0.5 s, for example. The time period t_min_drop_impact is preferably significantly shorter than the time period t_drop in the first configuration of the invention.

If, after the time period t_min_drop_impact has ended, the total acceleration increases again and, in particular, exceeds the first threshold value a_drop, a new time frame starts, which is referred to in the context of the invention as t_post_drop_impact. In the context of the invention, the increase in the total acceleration is preferably interpreted as the machine tool having being caught by the user or as the machine tool impacting with the floor or ground. The total acceleration therefore preferably increases if the machine tool is caught or impacts with the floor. In order to also ensure a reliable switch-off in this situation, the machine tool in this second configuration may be switched off or change its operating state if the total acceleration exceeds the second threshold value a_impact within this time period t_post_drop_impact. In accordance with the invention, it is preferred that a renewed or rapid increase in the total acceleration after the time period t_min_drop_impact has ended is interpreted as the machine tool having being caught or as an impact of the machine tool. In accordance with the invention, the second configuration of the invention described here is preferably also referred to as “drop & impact detection” since the rapid increase in the total acceleration and the associated exceeding of the second threshold value a_impact advantageously ensure that the machine is switched off reliably if it is suddenly decelerated, for example as a result of an impact of the machine. In accordance with the invention, it may also be preferred that the rapid increase in the total acceleration and the associated exceeding of the second threshold value a_impact is used as a starting point for changing an operating mode of the machine tool. By way of example, the machine tool, its tool and/or its motor may be decelerated if a rapid increase in the total acceleration and an exceeding of the second threshold value a_impact is established.

An essential advantage of the invention is that the proposed method for changing an operating state of a machine tool may be integrated and implemented in existing software packages in a particularly simple manner. The software or the proposed methods may be operated, for example, in a control apparatus or a processor of a machine tool. Owing to the simple structure of the method, only a low CPU usage of the control apparatus and/or the processor of the machine tool is required to implement the method.

In accordance with the invention, it is preferred that the first threshold value a_drop is lower than the second threshold value a_impact. Whilst the first threshold value a_drop is, for example, in a range of 5 to 60 % of a starting value of the total acceleration, the second threshold value a_impact may be, for example, 150% of the starting value of the total acceleration. In accordance with the invention, it is preferred that the second threshold value a_impact is in a range of 100 to 500 % of the starting value of the total acceleration and, especially preferably, in a range of 150 to 300 % of the starting value of the total acceleration.

In accordance with the invention, it is preferred that the time period t_post_drop_impact starts if the total acceleration exceeds the first threshold value a_drop. Moreover, in accordance with the invention, it is preferred that the time period t_min_drop_impact is a predetermined time period.

In accordance with the invention, it is preferred that the time period t_min_drop_impact is shorter than the time period t_drop, so that the alternative method for changing an operating state of a machine tool is used if the total acceleration does not fall below the first threshold value a_drop for long enough since an increase in the total acceleration has previously been detected.

In a second aspect, the invention relates to a machine tool for carrying out the proposed method. The terms, definitions and technical advantages introduced for the method for changing an operating state of a machine tool preferably apply analogously to the machine tool. The machine tool comprises an acceleration sensor for recording acceleration data and a control apparatus for evaluating the acceleration data recorded by the acceleration sensor.

In accordance with the invention, it is preferred that the acceleration data x, y and z are recorded in the three spatial directions, wherein a total acceleration can be ascertained based on the acceleration data in the three spatial directions. The machine tool may be preferably switched off if the total acceleration falls below a threshold value a_drop for longer than a time period t_drop.

In accordance with the invention, it is preferred that the machine tool is switched off or changes its operating state if the total acceleration falls below a threshold value a_drop for longer than a time period t_min_drop_impact and the total acceleration exceeds a second threshold value a_impact within a time period t_post_drop_impact.

In accordance with the invention, it is preferred that a decrease in the total acceleration is preferably interpreted in accordance with the invention as the machine tool having been dropped. Depending on the sensor type used to ascertain the acceleration values x, y and z, it may, however, also be preferred that an increase in the total acceleration is interpreted as the machine tool having been dropped.

When using a corresponding sensor type, the total acceleration during normal operation of the machine tool may assume a value of zero or close to zero. If the machine tool is dropped, the total acceleration in at least one of the spatial directions may increase to a value not equal to zero, for example to a value of 9,81 m/s², which corresponds to gravitational acceleration. In particular, in the “drop & impact detection” configuration of the invention, the total acceleration may then decrease again, for example back to a value close to zero, to then increase rapidly. The machine tool may be switched off, for example, or its motor or tool decelerated, if the total acceleration exceeds the second threshold value a_impact.

In this other configuration of the invention, which may be realized, for example, by a different sensor type for ascertaining the acceleration values x, y and z, the machine tool may be switched off, for example, or change its operating mode, if the total acceleration exceeds a threshold value a_drop for longer than a time period t_drop. In the “drop & impact detection” configuration of the invention, the machine tool may be switched off or change its operating state if the total acceleration exceeds a threshold value a_drop for longer than a time period t_min_drop_impact and the total acceleration exceeds a second threshold value a_impact within a time period t_post_drop_impact.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form sensible further combinations.

In the Figures:

FIG. 1 shows an exemplary time curve of the total acceleration in the case of “drop detection” according to the first configuration of the invention;

FIG. 2 shows an exemplary time curve of the total acceleration in the case of “drop & impact detection” according to the second configuration of the invention.

### DETAILED DESCRIPTION

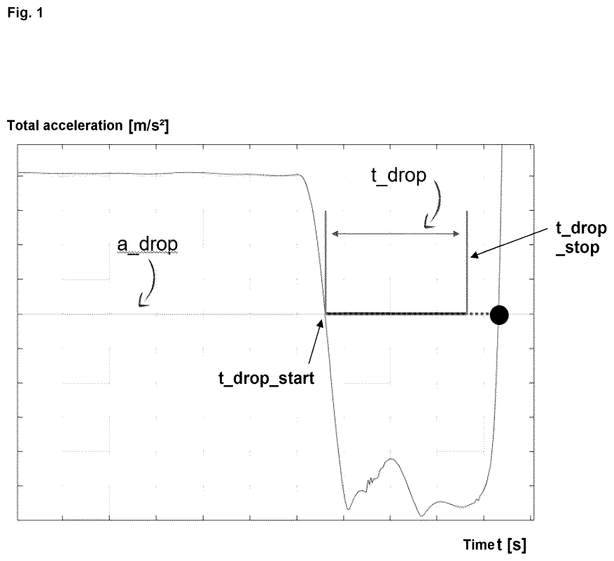

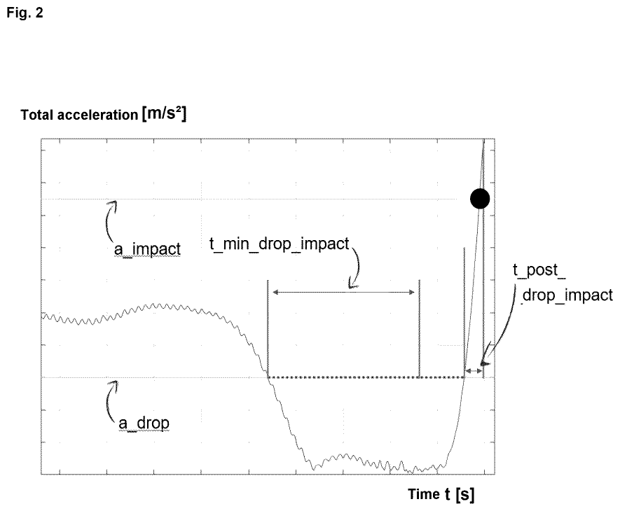

FIG. 1 shows an exemplary time curve of the total acceleration in the case of “drop detection” according to the first configuration of the invention. The total acceleration is plotted on the y axis of the plot shown in FIG. 1, wherein the total acceleration is preferably given in meters/(seconds)2 or in m/s². The time in seconds(s) is plotted on the x axis. During normal operation of the machine tool, the total acceleration has an exemplary starting value of ca. 10 m/s². If the machine tool falls to the floor during operation, this can be seen in the time curve of the total acceleration as a rapid drop in the total acceleration. The total acceleration may drop to a value of ca. 0 m/s² if the machine tool falls. If the total acceleration drops below the predetermined threshold value a_drop, the time period t_drop begins, at the end of which the machine tool is switched off or the machine tool changes its operating state, for example in that the machine tool, its tool and/or its motor is decelerated. The switch-off of the machine tool as an example of a change in the operating state of the machine tool is indicated by a black dot in FIGS. 1 and 2. The threshold value a_drop is ca. 60% of the original starting value of the total acceleration in the example illustrated in FIG. 1. It goes without saying that other values for the threshold value a_drop are also conceivable. The time period t_drop in the exemplary embodiment of the first configuration of the invention, which is illustrated in FIG. 1, is ca. 0.3 s.

FIG. 2 shows an exemplary time curve of the total acceleration in the case of “drop & impact detection” according to the first configuration of the invention. In the plot shown in FIG. 2, the same variables for the total acceleration are plotted in m/s² and the time is plotted in seconds(s). In addition to the first threshold value a_drop, the time periods t_min_drop_impact and t_post_drop_impact, and also the second threshold value a_impact, are shown in FIG. 2. The second threshold value a_impact in the exemplary embodiment of the second configuration of the invention, which is shown in FIG. 2, is significantly higher than the first threshold value a_drop.

The total acceleration firstly decreases as a result of the machine tool having being dropped and assumes a value of ca. 0 m/s², for example. With this decrease in the total acceleration, the total acceleration falls below the first threshold value a_drop, whereby the first time period t_min_drop_impact begins. The time period t_min_drop_impact is preferably shorter than the time period t_drop of the first configuration of the invention and is, for example, 0.15 s. If, when the time period t_m_drop_impact has ended, the total acceleration is still below the first a_drop and then increases again—for example because the machine tool has impacted with the ground—a second time period t_post_drop_impact begins. The second time period t_post_drop_impact preferably begins if the total acceleration-starting from low values-exceeds the first threshold value a_drop. The collision or impact of the machine tool preferably results in a very rapid increase in the total acceleration, so that the total acceleration intersects and exceeds the second, higher threshold value a_impact after a short time. At this point, according to the second configuration of the invention, the machine tool is switched off or its operating state is changed, wherein a switch-off point in this second configuration of the invention is preferably within the second time period t_post_drop_impact. The switch-off of the machine tool or a change in the operating state of the machine tool, such as a deceleration, is also indicated by a black dot in FIG. 2.

What is claimed is:

1-14 (canceled)

15. A method for changing an operating state of a machine tool, the method comprising the following steps:
a) providing a machine tool with an acceleration sensor;
b) recording an acceleration of the machine tool in three spatial directions to obtain acceleration values x, y and z;
c) ascertaining a total acceleration of the machine tool based on the acceleration values x, y and z;
d) comparing the total acceleration to a threshold value a_drop; and
e) changing an operating state of the machine tool if the total acceleration falls below the threshold value a_drop for longer than a time period t_drop.

16. The method as recited in claim 15 wherein the decrease in the total acceleration is interpreted as the machine tool having been dropped.

17. The method as recited in claim 15 wherein the total acceleration for the time period t_drop drops to values of less than 25 % of an original starting value of the total acceleration.

18. The method as recited in claim 15 wherein the time period t_drop is in a range of 0.1 to 1 s.

19. A method for changing an operating state of a machine tool, the method comprising the following steps:
a) providing a machine tool with an acceleration sensor;
b) recording an acceleration of the machine tool in the three spatial directions to obtain acceleration values x, y and z;
c) ascertaining a total acceleration of the machine tool based on the acceleration values x, y and z;
d) comparing the total acceleration to a first threshold value a_drop;
e) changing an operating state of the machine tool if the total acceleration falls below the threshold value a_drop for longer than a time period t_min_drop_impact and the total acceleration exceeds a second threshold value a_impact within a time period t_post_drop_impact.

20. The method as recited in claim 19 wherein the first threshold value a_drop is lower than the second threshold value a_impact.

21. The method as recited in claim 19 wherein the time period t_post_drop_impact starts if the total acceleration exceeds the first threshold value a_drop.

22. The method as recited in claim 19 wherein the time period t_min_drop_impact is a predetermined time period.

23. The method as recited in claim 19 wherein the renewed increase in the total acceleration after the time period t_min_drop_impact has ended is interpreted as the machine tool having been caught or as an impact of the machine tool.

24. The method as recited in claim 19 wherein the time period t_min_drop_impact is shorter than the time period t_drop.

25. A machine tool for carrying out the method as recited in claim 19 wherein the machine tool comprises an acceleration sensor for recording acceleration data and a control apparatus for evaluating the acceleration data recorded by the acceleration sensor.

26. The machine tool as recited in claim 25 wherein the acceleration data x, y and z are recorded in the three spatial directions, wherein the total acceleration can be ascertained based on the acceleration data in the three spatial directions.

27. The machine tool as recited in claim 25 wherein the machine tool can be switched off if the total acceleration falls below a threshold value a_drop for longer than a time period t_min_drop_impact and the total acceleration exceeds a second threshold value a_impact within a time period t_post_drop_impact.

28. A machine tool for carrying out the method as recited in claim 15 wherein the machine tool comprises an acceleration sensor for recording acceleration data and a control apparatus for evaluating the acceleration data recorded by the acceleration sensor.

29. The machine tool as recited in claim 28 wherein the acceleration data x, y and z are recorded in the three spatial directions, wherein the total acceleration can be ascertained based on the acceleration data in the three spatial directions.

30. The machine tool as recited in claim 28 wherein the machine tool can be switched off if the total acceleration falls below the threshold value a_drop for longer than the time period t_drop.
